(19) United States
(12) Patent Application Publication
(10) Pub. No.: US 2026/0111853 A1
(43) Pub. Date: Apr. 23, 2026

(54) Systems And Methods For Managing Maintenance-Related Information

(71) Applicant: Steven Scannapieco, Richboro, PA (US)

(72) Inventor: Steven Scannapieco, Richboro, PA (US)

(21) Appl. No.: 19/423,287

(22) Filed: Dec. 17, 2025

Related U.S. Application Data
(63) Continuation-in-part of application No. 18/647,638, filed on Apr. 26, 2024, now Pat. No. 12,524,743.
(60) Provisional application No. 63/638,081, filed on Apr. 24, 2024.

(51) Int. Cl. G06Q 10/20; G06Q 40/12

(52) U.S. Cl. CPC G06Q 10/20; G06Q 40/126

(57) ABSTRACT

A system for managing maintenance-related information includes a master management system configured to communicate with one or more client companies; and one or more technician devices in communication with the master management system; wherein each technician device of the one or more technician devices is configured to display and to elicit entry of maintenance-related information from a technician for one or more maintenance jobs, and wherein the maintenance-related information includes time worked for a maintenance job of the one or more maintenance jobs.

### STATEMENT OF RELATED APPLICATION(S)

This application is a continuation-in-part of U.S. patent application Ser. No. 18/647,638, entitled “Maintenance Management Software and Methods of Performing the Same”, filed on Apr. 26, 2024, which claims the benefit of U.S. Provisional Patent Application No. 63/638,081, entitled “Maintenance Management Software and Methods of Performing the Same”, filed Apr. 24, 2024, the disclosures of which are hereby incorporated by reference herein in their entirety.

### TECHNICAL FIELD

The present invention relates to the field of maintenance management systems dispersed in wide geographical areas.

### BACKGROUND

For maintenance companies with repair technicians geographically dispersed over wide areas, accurate and timely capture of time and expenses related specific maintenance jobs is often difficult. Work time may be entered by technicians days after the fact with less than total reliability of accuracy. Further, receipts for expenses incurred may be lost between the expense occurring and the ability to physically turn the receipts in for reimbursement. Existing systems, where data is entered days after the fact, lead to over- and under-charging of clients for time spent and expenses incurred.

Therefore, a need exists for a system for managing maintenance-related information in real time with verifiable expense tracking for audit purposes.

### SUMMARY

In a first aspect of the claimed invention, a system for managing maintenance-related information includes a master management system configured to communicate with one or more client companies; and one or more technician devices in communication with the master management system; wherein each technician device of the one or more technician devices is configured to display and to elicit entry of maintenance-related information from a technician for one or more maintenance jobs, and wherein the maintenance-related information includes time worked for a maintenance job of the one or more maintenance jobs.

In another aspect of the invention, the technician device is a portable electronic device configured to run a software application.

In another aspect of the invention, the portable electronic device is a cellular phone or a tablet, and the portable electronic device comprises a camera, the software application elicits the technician to create a receipt entry for each expense receipt of one or more expense receipts associated with a maintenance job of the one or more maintenance jobs, and each receipt entry comprises receipt data and a corresponding image of the expense receipt taken by the portable electronic device or uploaded by the technician to the software application, and each receipt entry is transmitted from the technician device to a receipt repository in the master maintenance system.

In another aspect of the invention, the receipt data comprises a receipt date, a receipt total, and a receipt category.

In another aspect of the invention, when time worked for a maintenance job has been entered, the software application automatically generates a corresponding expense report for the maintenance job.

In another aspect of the invention, once the expense report has been generated, the software application elicits the technician to select one or more receipt entries from the receipt repository associated with the corresponding maintenance job to be populated into the expense report.

In another aspect of the invention, the maintenance-related information further comprises a description of services rendered for the maintenance job and comments by the technician regarding the maintenance job.

In another aspect of the invention, the maintenance-related information further comprises a checklist of tasks to be completed for a client facility of the client company for the maintenance job.

In another aspect of the invention, the maintenance-related information further comprises a log of repair parts used during the maintenance job.

In another aspect of the invention, the maintenance-related information further comprises site information of a client facility of the client company for the maintenance job.

In another aspect, any one or more aspects or features described herein may be combined with any one or more other aspects or features for additional advantage.

Other aspects and embodiments will be apparent from the detailed description and accompanying drawings.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a schematic diagram of a system for managing maintenance-related information according to a first embodiment of the present invention.

FIG. 2 is a view of a software application useable on a technician device of the system of FIG. 1, showing a home page.

FIG. 3A is a view of a software application useable on a technician device of the system of FIG. 1, showing a receipt entry page.

FIG. 3B is a view of a software application useable on a technician device of the system of FIG. 1, showing data entry of receipt information.

FIG. 3C is a view of a software application useable on a technician device of the system of FIG. 1, showing data entry of additional receipt information.

FIG. 4 is a view of a software application useable on a technician device of the system of FIG. 1, showing a receipt table.

FIG. 5 is a view of a software application useable on a technician device of the system of FIG. 1, showing a job table.

FIG. 6 is a view of a software application useable on a technician device of the system of FIG. 1, showing a time entry screen.

FIG. 7 is a view of a software application useable on a technician device of the system of FIG. 1, showing an exemplary expense report.

FIG. 8 is a view of a software application useable on a technician device of the system of FIG. 1, showing associating a receipt with an expense report.

FIG. 9 is a view of a software application useable on a technician device of the system of FIG. 1, showing populating an expense report based on associated data entry.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

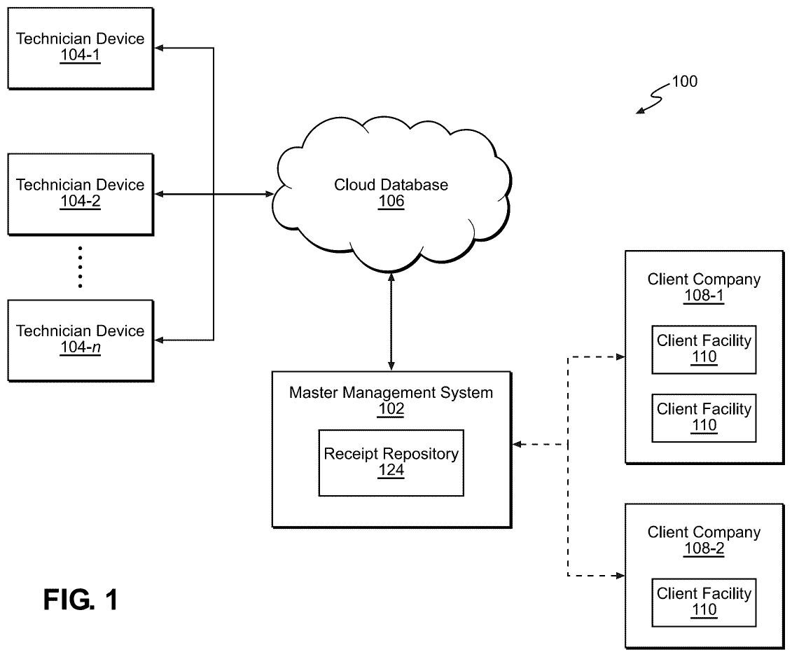

Referring now to FIG. 1, a schematic diagram of a system for managing maintenance-related information 100 is shown. The system 100 includes a master management system 102, one or more technician devices 104, a cloud database, one or more client companies 108 each having one or more client facilities 110. In an exemplary embodiment, the master management system 102 is configured to communicate with the one or more technician devices 104 via the cloud database 106. In an exemplary embodiment, the communication between the master management system 102 and the one or more technician devices 104 may be accomplished through a wired connection (such as a local area network [LAN]), may be accomplished through a wireless connection within a local area (such as a wireless local area network [WLAN]), or may be accomplished remotely over an extended network (such as a cellular network). Each of the master management system 102 and the one or more technician devices 104 are configured to both send and receive information to any other device connected via the cloud database 106. In an exemplary embodiment, the one or more technician devices 104 may comprise one technician device 104, two technician devices 104, and/or n technician devices 104. Each technician device 104-1, 104-2, 104-n may be configured as a cellular phone, a tablet, a laptop, a personal computer, and/or any other suitable electronic device.

In an exemplary embodiment, the master management system 102 is configured to communicate with one or more client companies 108. Each client company 108 of the one or more client companies 108 is configured to have at least one associated client facility 110. For example, a first client company 108-1 may comprise two client facilities 110. In another example, a second client company 108-2 may comprise one client facility 110. For each client facility 110, the client company 110 will require repair and/or maintenance on components of the client facility 110 on a quarterly basis, on an annual basis, on an emergency basis, and/or on any other periodic basis. Each client company 108 utilizes maintenance management software to monitor each client facility 110 and to schedule necessary maintenance on the periodic basis. The details of the Maintenance Management Software are disclosed in U.S. patent application Ser. No. 18/647,638, entitled “Maintenance Management Software and Methods of Performing the Same”, which is incorporated by reference herein in its entirety. In an exemplary embodiment, each client company 108 is configured to communicate with the master management system 102 to request and schedule necessary maintenance for an associated client facility 110.

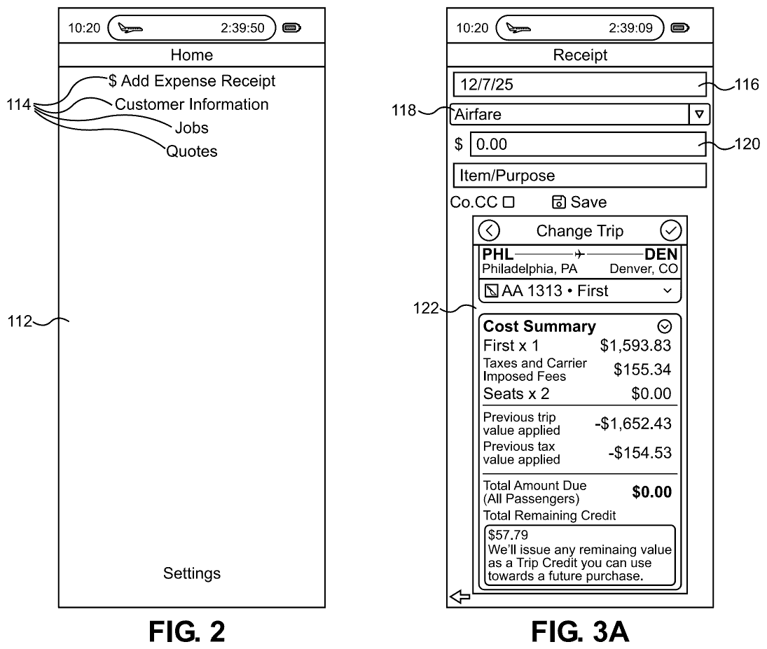

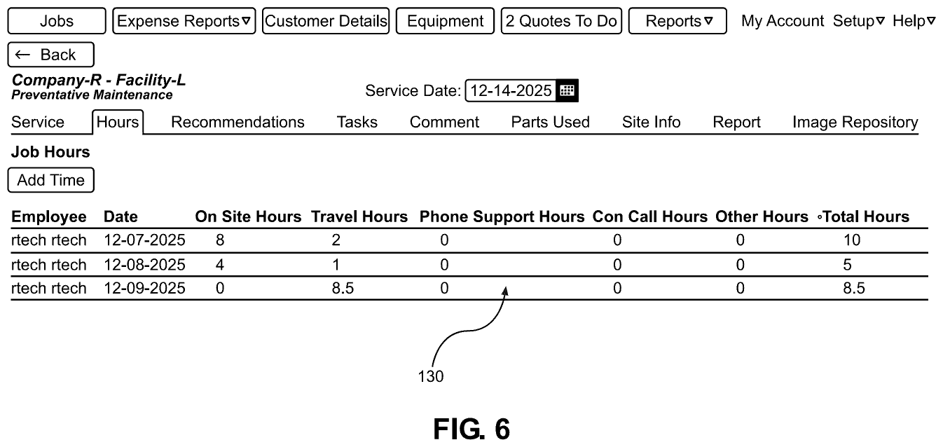

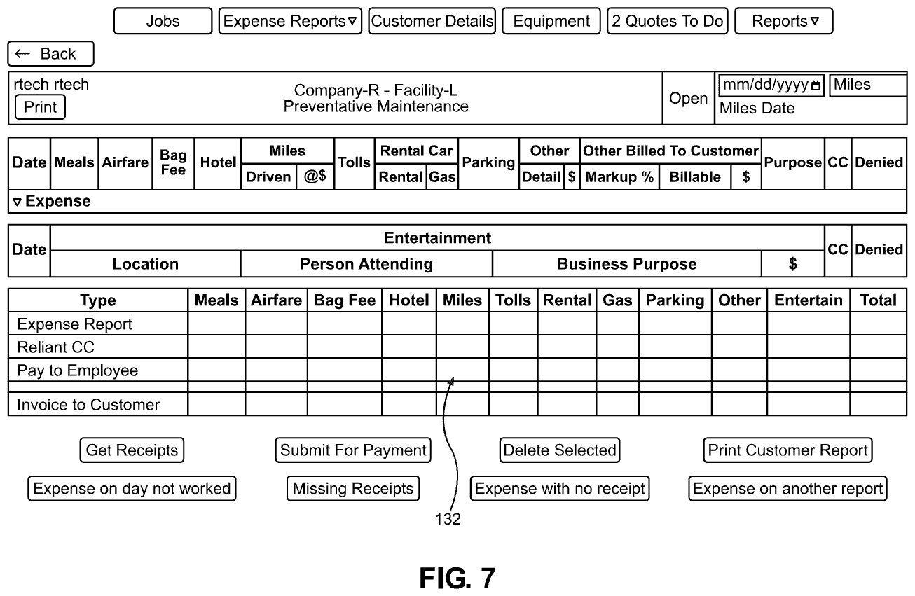

Referring now to FIGS. 2-9, various views of a software application usable on a technician device 104 are shown. In an exemplary embodiment, the technician device 104 comprises a software application to facilitate communication of maintenance-related information to the cloud database 106. Referring specifically to FIG. 2, the technician device 104 comprises a home screen 112 which presents several functions 114 available for selection by a technician utilizing the technician device 104. In an exemplary embodiment, the functions 114 may facilitate the technician looking up information regarding a particular client company 108, looking up information about a particular maintenance job, generating a quote for a maintenance job, adding expense receipts to the system 100, and/or any other suitable functions.

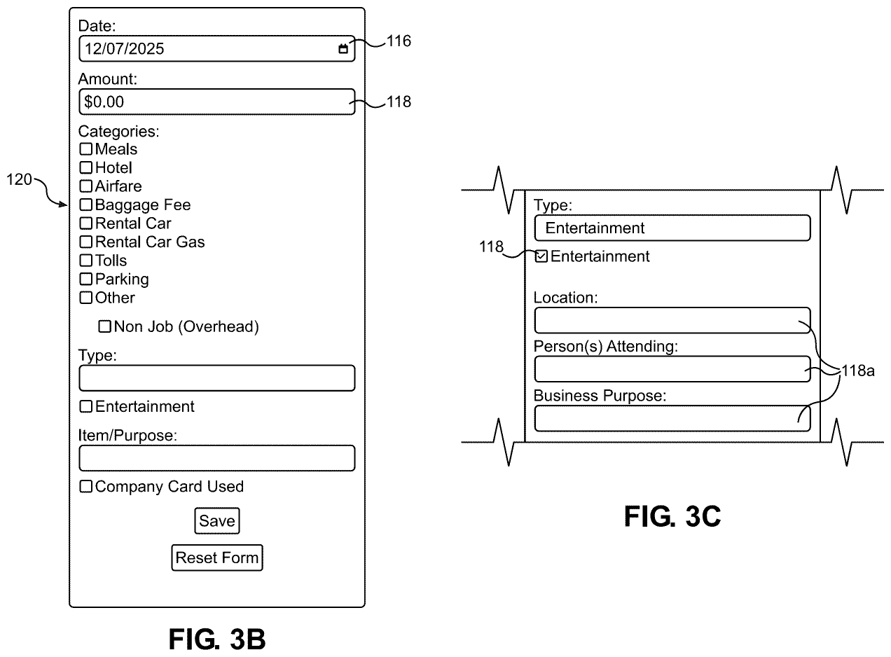

Referring now specifically to FIGS. 3A-3C, if the technician selects the function 114 to add expense receipts to the system 100, the technician will be elicited by the system 100 to input required information. In an exemplary embodiment, the technician will be elicited to enter a receipt date 116, a receipt category 118, a receipt total 120, and a receipt image 122. The technician is elicited to input the receipt date 116 (as shown on the receipt) and the receipt total 120 as user-editable text information in the software application. For the receipt category 118, the technician is elicited to select from a list of categories under which the expense falls (see FIG. 3B). Exemplary categories include, but are not limited to, meals, hotel, airfare, baggage fee, rental car, rental car gas, tolls, parking, entertainment, and other. In an exemplary embodiment, certain of the selected categories may require the input of additional information 118a. By way of non-limiting example, if the selected category is “entertainment”, the technician will be further elicited to input a location, to list the names of people attending, and to list the business purpose of the entertainment. In an exemplary embodiment, the software application may also be configured to elicit from the technician whether a company credit card was used to pay for the expense, which may be utilized to appropriately reimburse the employee for the expense.

In an exemplary embodiment, the technician device 104 is configured as a cellular phone or tablet that includes a camera. In this embodiment, the technician may utilize the phone camera to take an image of the receipt and directly upload the captured image to the software application. Alternatively, the technician may select a digital receipt from a 3^{rd} party vendor to be uploaded to the software application. In another exemplary embodiment, the technician device 104 is configured as a laptop or personal computer. In this embodiment, the technician may have the option to upload a photograph of the receipt taken with another device or may upload a digital receipt from a 3^{rd} party vendor. Once the technician has entered the pertinent receipt information and uploaded the receipt image 122, the technician device 104 transmits the data, via the cloud database 106, to the master management system 102 for secure storage in a receipt repository 124.

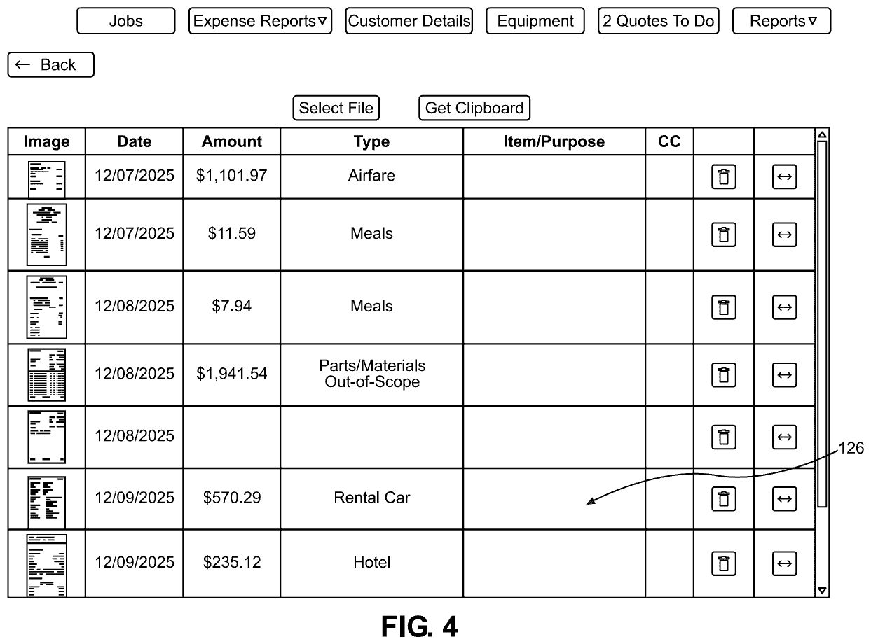

Referring now specifically to FIG. 4, the technician device 104 is configured to be able access all uploaded receipts stored within the receipt repository 124. The software application displays all stored receipts in a receipt table 126 and displays the relevant information to the technician. By way of non-limiting example, the receipt table 126 displays at least the receipt date 116, receipt total 120, and receipt category 118. In an exemplary embodiment, the receipt table 126 may be sortable based on any of the displayed information. In an exemplary embodiment, the receipt table 126 may further display a thumbnail version of the receipt image 122. In another exemplary embodiment, the receipt table 126 may be configured to allow the technician to perform several actions with respect to the stored receipt data. For example, the technician may select one or more stored receipts for deletion from the receipt repository 124. In another example, the software application may be configured to allow the technician to split the receipt total 120. In this example, a single receipt may be associated with two or more maintenance jobs at two or more client companies 108 and/or two or more client facilities 110. When a receipt has been split by the technician, the receipt repository 124 creates a duplicate entry of the receipt with the split receipt total 120, usable with each maintenance job.

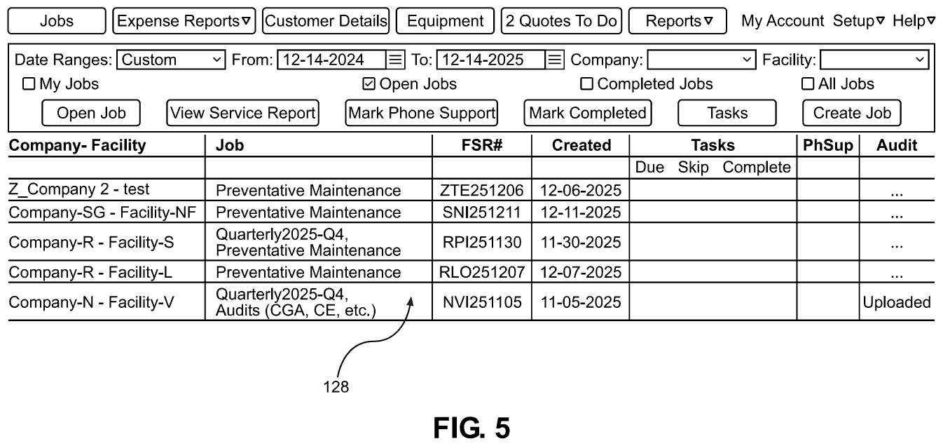

Referring now specifically to FIGS. 5-9, the software application may be further configured to allow the technician to create expense reports associated with each maintenance job. In an exemplary embodiment, the software application is configured to display a job table 128 to the technician. The job table 128 facilitates the technician to perform time entry 130 for all time spent working on a maintenance job. The software application elicits the technician to list all hours worked for each client company 108 and associated client facility 110 for which a maintenance job was performed. The time entry 130 requires all entered hours to be categorized (such as on-site hours, travel hours, phone support hours, etc.). Once the time entry 130 has been completed by the technician, the software application automatically generates an expense report 132 associated with the particular maintenance job.

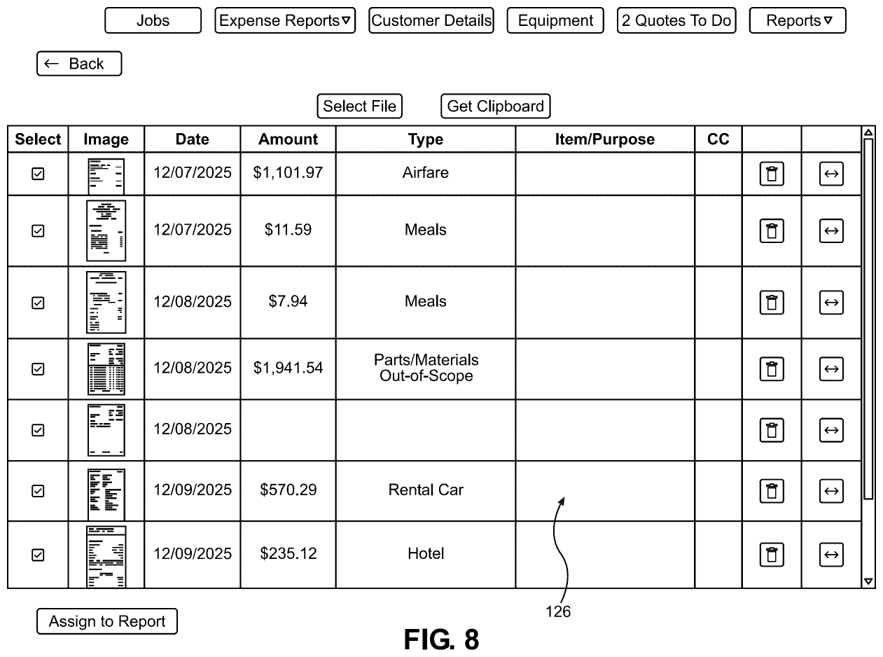

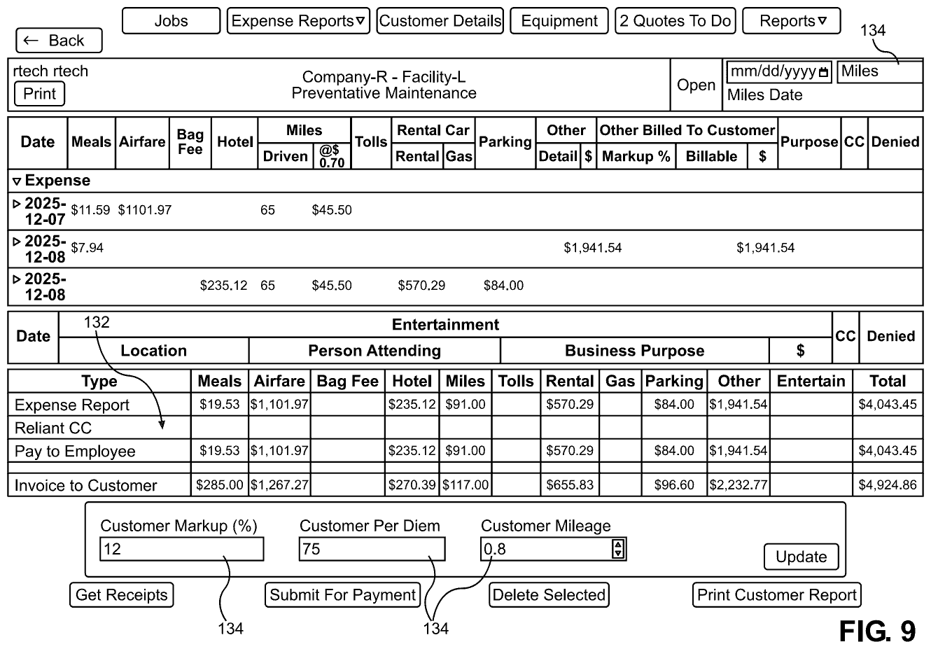

In an exemplary embodiment, within the expense report 132, the software application facilitates the technician to select one or more associated receipts stored within the receipt repository 124 to be associated with the expense report 132. In an exemplary embodiment, the software application displays at least a portion of the receipt table 126 of the receipt repository 124 to the technician (see FIG. 8). For example, the software application may only display those receipts in the receipt table 126 which have not been associated with an expense report 132 yet and does not display those receipts which are already associated with an expense report 132. The software application elicits the technician to select one or more receipts from the receipt table 124. Once selection of associated receipts is completed, the software application populates the expense report 132 with the associated receipt information (see FIG. 9). In an exemplary embodiment, the expense report 132 further facilitates the technician to enter additional information 134. By way of non-limiting example, the additional information 134 may include mileage driven in a personal vehicle, a percentage markup, a per diem cost for the client company 108, a mileage rate for the client company 108, and/or any other suitable additional information. Once all relevant information has been captured within the expense report 132, the technician may submit the expense report 132 to the master management system 102 via the cloud database 106.

In an exemplary embodiment, an admin utilizing the master management system 102 may approve the expense report 132 submitted by the technician, which allows for the technician to be reimbursed for out-of-pocket expenses as well as for invoicing of costs to the client company 108. In an exemplary embodiment, the software application further elicits the technician to input notes or recommendations for future maintenance jobs associated with the corresponding client facility 110.

In use, the system 100 facilitates each of the one or more technician devices 104 to be taken by a technician to a client facility 110 for a maintenance job. The system 100 allows the technician to upload and record all relevant job-related information in real time, thereby reducing incorrect data entry or missed expenses from delayed data entry.

Those skilled in the art will recognize improvements and modifications to the preferred embodiments of the present disclosure. All such improvements and modifications are considered within the scope of the concepts disclosed herein and the claims that follow.

What is claimed is:

1. A system for managing maintenance-related information, the system comprising:
a master management system configured to communicate with one or more client companies; and
one or more technician devices in communication with the master management system;
wherein each technician device of the one or more technician devices is configured to display and to elicit entry of maintenance-related information from a technician for one or more maintenance jobs, and
wherein the maintenance-related information comprises time worked for a maintenance job of the one or more maintenance jobs.

2. The system of claim 1, wherein the technician device is a portable electronic device configured to run a software application.

3. The system of claim 2, wherein:
the portable electronic device is a cellular phone or a tablet, and the portable electronic device comprises a camera,
the software application elicits the technician to create a receipt entry for each expense receipt of one or more expense receipts associated with a maintenance job of the one or more maintenance jobs, and
each receipt entry comprises receipt data and a corresponding image of the expense receipt taken by the portable electronic device or uploaded by the technician to the software application, and each receipt entry is transmitted from the technician device to a receipt repository in the master maintenance system.

4. The system of claim 3, wherein the receipt data comprises a receipt date, a receipt total, and a receipt category.

5. The system of claim 3, wherein, when time worked for a maintenance job has been entered, the software application automatically generates a corresponding expense report for the maintenance job.

6. The system of claim 5, wherein, once the expense report has been generated, the software application elicits the technician to select one or more receipt entries from the receipt repository associated with the corresponding maintenance job to be populated into the expense report.

7. The system of claim 1, wherein the maintenance-related information further comprises a description of services rendered for the maintenance job and comments by the technician regarding the maintenance job.

8. The system of claim 1, wherein the maintenance-related information further comprises a checklist of tasks to be completed for a client facility of the client company for the maintenance job.

9. The system of claim 1, wherein the maintenance-related information further comprises a log of repair parts used during the maintenance job.

10. The system of claim 1, wherein the maintenance-related information further comprises site information of a client facility of the client company for the maintenance job.
